(19) United States
(12) Patent Application Publication
(10) Pub. No.: US 2006/0045149 A1
(43) Pub. Date: Mar. 2, 2006

(54) Laser scanning device

(75) Inventor: Toshio Kasai, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/211,639

(22) Filed: Aug. 26, 2005

(30) Foreign Application Priority Data
Aug. 27, 2004 (JP) 2004-247812

(51) Int. Cl. H01S 3/10

(52) U.S. Cl. 372/24

(57) ABSTRACT

A laser scanning device that scans a laser beam on a photosensitive surface includes a laser emitting system, a first board mounting the laser emitting system, a laser scanning system configured to receive the laser beam emitted from the laser emitting system and scan the laser beam in a scanning direction, a laser detecting system configured to detect the laser beam to output laser detecting signals, and a second board mounting the laser detecting system. The laser emitting system is adapted to emit the laser beam in a direction substantially parallel to the surface of the first board. The laser detecting system is adapted to detect the laser beam coming from a direction parallel to the surface of the first board. Each of the first and second boards is arranged with the surface thereof substantially parallel to the scanning direction.

### BACKGROUND OF THE INVENTION

The present invention relates to a laser scanning device configured to scan a laser beam to form an image, in particular, a thinned laser scanning device.

FIG. 9 shows an example of a conventional laser scanning device, which is disclosed in Japanese Utility Model Publication No. 2601248. This conventional laser scanning device is configured such that a laser beam emitted from a laser source (LD unit) 2A is collimated by a collimating lens 3, and is scanned in one direction (main scanning direction) by a first scanning optical system including a rapidly rotating polygon mirror 5 and an fθ lens that enables to scan the laser beam at constant speed, and is then reflected by a reflecting mirror 7, and is further directed to a photosensitive surface of a photoconductive drum that is not shown in FIG. 9 through a slit 8 to expose the photosensitive surface therewith. At the same time, the photoconductive drum is rotated in a direction (i.e., an auxiliary scanning direction) perpendicular to the main scanning direction to carry out an auxiliary scanning, and thereby a required pattern (i.e., a latent image) is exposed on the photosensitive surface. Moreover, so as to get in exact scanning timing while carrying out the main laser scanning, the laser scanning device is configured to control timing for modulating the laser beam emitted by the LD unit 2A based on output signals of a beam detecting sensor (BD unit) 9A that is provided to receive a part of the scanned laser beam reflected by a mirror 10. In addition, the LD unit 2A and the BD unit 9A are electrically connected with one another and external devices through a flat cable 11. This kind of laser scanning device is constituted as a laser scanning optical system unit that is integrally provided with the LD unit 2A, the collimating lens 3, the polygon mirror 5, the fθ lens, etc. in a housing. A laser printer is configured to have the laser scanning unit and the photoconductive drum.

In recent years, thinning down of the entire laser scanning device is promoted by downsizing and/or thinning down the polygon mirror and fθ lens. For instance, the laser scanning device (laser scanning optical system unit) disclosed in Japanese Utility Model Publication No. 2601248 shown in FIG. 9 is designed to have a required shape of the housing 1 with a peripheral wall 1a of which height is reduced, and by minifying the heights of the polygon mirror 5 and the fθ lens provided in the housing 1, the height of the laser scanning device is reduced, and thereby the laser scanning device with near low profile is attained. Especially, in the case of a tandem construction of color printer into which a plurality of laser scanning devices are integrally incorporated as described in Japanese Patent Provisional Publications No. P2000-122355, since the plurality of laser scanning devices need to be piled, each of the laser scanning devices is desired to be formed thinner in order to reduce the height of the whole color printer.

In the laser scanning device disclosed in Japanese Utility Model Publication No. 2601248, so as to direct the laser beam emitted from the LD unit 2A to the reflecting surfaces of the polygon mirror 5 to scan the laser beam in a horizontal direction, it is necessary to make the laser beam emit in a direction parallel to a plane of rotation of the polygon mirror 5, that is, in a direction parallel to a bottom face 1b of the housing 1, because the polygon mirror 5 is generally arranged such that the plane of rotation thereof is parallel to the bottom face 1b of the housing 1. Since a conventional LD unit 2A is configured such that a laser beam emits in a direction perpendicular to a surface of a circuit board (hereinafter, referred to as an LD board 20A) on which a laser diode (LD) is mounted, the LD board 20A needs to be incorporated into the laser scanning device with the surface thereof facing the peripheral wall 1a of the housing 1. In addition, since there are provided a driving circuit for driving the LD to emit the laser beam, a peripheral circuit, and connecters, as well as the LD, on the LD board 20A, there are limitations in reduction of the side length of the LD board 20A. For these reasons, in such a laser scanning device including the LD board 20A, even though the heights of the polygon mirror 5 and/or the fθ lens 6 are reduced, it is difficult to make the height of the laser scanning device smaller than the vertical side length of the LD board 20A (the side length of the LD board 20A perpendicular to the bottom face 1b).

In addition, the BD unit 9A provided in the laser scanning device is configured to be mounted on a circuit board (hereinafter, the board being referred to as a BD board 90A). Since a conventional BD board 90A is configured to receive a laser beam from a direction perpendicular to the surface of the BD board 90A, the BD board 90A needs to be arranged such that the surface thereof extends in a direction perpendicular to the bottom face 1b of the housing 1. Since there must be provided required circuit components, as well as a photo diode (PD), on the BD board 90A, there are limitations in reduction of the side length of the BD board 90A, and therefore, similar to the case of the LD board 20A, thinning-down of the laser scanning device is restricted by the side length of the BD board 90A.

One of solutions to such problems is to apply a multilayer circuit wiring technology to the LD board 20A and the BD board 90A to reduce a necessary wiring area on each of the boards and thereby minimize the depth and/or width thereof. Such a technology enables to reduce the height of the laser scanning device even if each of the LD board 20A and the BD board 90A is placed with the surface thereof perpendicular to the bottom face 1b in the housing 1. However, in general, since a circuit board with a multilayer wiring structure is expensive, the laser scanning device employing the LD board 20A and the BD board 90A with such structures is undesirable in cost reduction of the laser scanning device.

### SUMMARY OF THE INVENTION

The present invention is advantageous in that an improved laser scanning device is provided that is configured thin-shaped by reducing the height thereof without being restrained by the side length of an LD unit and/or a BD unit.

According to an aspect of the invention, there is provided a laser scanning device capable of scanning a laser beam on a photosensitive surface including a laser emitting system configured to emit the laser beam to be scanned, a first board mounting the laser emitting system, and a laser scanning system configured to receive the laser beam emitted from the laser emitting system and scan the laser beam in a scanning direction. The laser emitting system is adapted to emit the laser beam in a direction substantially parallel to the surface of the first board, and the first board is arranged with the surface thereof substantially parallel to the scanning direction.

Optionally, the laser scanning device may include a laser detecting system configured to detect the laser beam to output laser detecting signals. Preferably, the laser detecting system, which is mounted on the surface of the first board, may be adapted to detect the laser beam coming from a direction parallel to the surface of the first board.

Optionally, the laser scanning device may include a laser detecting system configured to detect the laser beam to output laser detecting signals and a second board mounting the laser detecting system. Further, the laser detecting system may be adapted to detect the laser beam coming from a direction parallel to the surface of the second board, which is arranged with the surface thereof substantially parallel to the scanning direction.

Yet optionally, the laser scanning system may include a low-profile polygon mirror that is configured to scan the laser beam in the scanning direction by rotation with a plane of rotation which is parallel to the scanning direction.

Further optionally, the laser scanning system may include a scanning speed controlling system that is configured to control the laser beam reflected by the polygon mirror to be scanned in the scanning direction with constant scanning speed.

Optionally, the laser emitting system may include a laser emitting device that emits the laser beam, and a laser driving system that drives the laser emitting device.

Further optionally, the laser emitting system may include a laser monitoring device that receives a part of the laser beam emitted from the laser emitting device and outputs a current depending on the intensity of the laser beam, and a light intensity calculating system that calculates the intensity of the laser beam from the current and outputs light intensity signals. Preferably, the laser driving system may control the laser emitting device to emit the laser beam with required intensity based on the light intensity signals.

Optionally, the laser detecting system may include a laser detecting device that receives a part of the laser beam emitted from the laser emitting device and outputs a current depending on the light intensity of the received laser beam, and a laser detecting signal generating system that generates laser detecting signals on the basis of the current.

Yet optionally, the laser detecting device may include a laser detecting surface on which the laser beam to be detected is incident, the laser detecting surface being substantially parallel to the scanning direction. Further, the laser detecting system may include a laser direction changing system that is configured to change the direction of the laser beam such that the laser beam is incident on the laser detecting surface.

Optionally, the laser direction changing system may be configured employing at least one of a reflecting device that reflects the laser beam, a deflecting device that deflects the laser beam, and a diffracting device that diffracts the laser beam.

According to another aspect of the invention, there is provided a laser scanning device capable of scanning a laser beam on a photosensitive surface including a laser emitting system configured to emit the laser beam to be scanned, the laser emitting system including a laser emitting device that emits the laser beam, a laser driving system that drives the laser emitting device, a laser monitoring device that receives a part of the laser beam emitted from the laser emitting device and outputs a current depending on the intensity of the laser beam, and a light intensity calculating system that calculates the intensity of the laser beam from the current and outputs light intensity signals, a laser detecting system configured to detect the laser beam to output laser detecting signals, the laser detecting system including a laser detecting device that receives a part of the laser beam emitted from the laser emitting device and outputs a current depending on the light intensity of the received laser beam, and a laser detecting signal generating system that generates laser detecting signals on the basis of the current, a first board mounting the laser emitting system and the laser detecting system, and a laser scanning system configured to receive the laser beam emitted from the laser emitting system and scan the laser beam in a scanning direction. The laser emitting system is adapted to emit the laser beam in a direction substantially parallel to the surface of the first board. The laser driving system controls the laser emitting device to emit the laser beam with required intensity based on the light intensity signals. The laser detecting system is adapted to detect the laser beam coming from a direction parallel to the surface of the first board. The first board is arranged with the surface thereof substantially parallel to the scanning direction.

Optionally, the laser scanning device may include a controlling system that controls timing for modulating the laser beam.

Still optionally, the controlling system may include a synchronous detecting system that receives the laser detecting signals from the laser detecting signal generating system of the laser detecting system and outputs synchronizing signals, and a drawing signal generating system that receives externally-inputted drawing data and the laser detecting signals, and generates synchronized drawing signals. Optionally, the drawing signals are transmitted to the drive controlling system in order to control the laser emitting device to emit the laser beam with required timing.

According to a further aspect of the invention, there is provided a laser scanning device capable of scanning a laser beam on a photosensitive surface including a laser emitting system configured to emit the laser beam to be scanned, the laser emitting system including a laser emitting device that emits the laser beam, a laser driving system that drives the laser emitting device, a laser monitoring device that receives a part of the laser beam emitted from the laser emitting device and outputs a current depending on the intensity of the laser beam, and a light intensity calculating system that calculates the intensity of the laser beam from the current and outputs light intensity signals, a first board mounting the laser emitting system, a laser scanning system configured to receive the laser beam emitted from the laser emitting system and scan the laser beam in a scanning direction, a laser detecting system configured to detect the laser beam to output laser detecting signals, the laser detecting system including a laser detecting device that receives a part of the laser beam emitted from the laser emitting device and outputs a current depending on the light intensity of the received laser beam, and a laser detecting signal generating system that generates laser detecting signals on the basis of the current, and a second board mounting the laser detecting system. The laser emitting system is adapted to emit the laser beam in a direction substantially parallel to the surface of the first board. The laser driving system controls the laser emitting device to emit the laser beam with required intensity based on the light intensity signals. The laser detecting system is adapted to detect the laser beam coming from a direction parallel to the surface of the second board. Each of the first and second boards is arranged with the surface thereof substantially parallel to the scanning direction.

### BRIEF DESCRIPTION OF THE ACCOMPANYING DRAWINGS

FIG. 1 is a schematic perspective view of a laser scanning device according to a first embodiment of the present invention;

FIGS. 2A and 2B are a schematic perspective view and a schematic side view of an LD unit according to the first embodiment, respectively;

FIGS. 3A and 3B are a schematic perspective view and a schematic side view of a BD unit according to the first embodiment, respectively;

FIG. 4 is a schematic side view of an optical system of the laser scanning device according to the first embodiment;

FIG. 5 is a block diagram illustrating an electrical circuit configuration of the laser scanning device;

FIG. 6 is a schematic perspective view of a laser scanning device according to a second embodiment of the present invention;

FIGS. 7A and 7B are a top view and a side view of an LD-BD unit according to the second embodiment, respectively;

FIGS. 8A, 8B, and 8C are side views of variation examples of the BD unit; and

FIG. 9 is a schematic perspective view of an example of a conventional laser scanning device.

### DETAILED DESCRIPTION OF THE EMBODIMENTS

In each embodiment described below, an LD unit may be provided with a laser diode, and may be integrated with semiconductor devices constituting a driving circuit for driving the laser diode, or may be configured as an integrally packaged semiconductor device. Further, the driving circuit may be configured as a semiconductor device that is integrated with a light receiving device for monitoring a part of a laser beam emitted from the laser diode.

Further, the light receiving device may be configured as a semiconductor device that is integrated with a light receiver circuit for processing light receiving signals. In this case, a light receiving surface of the light receiving device may be configured to be parallel to a surface of a circuit board and include a light direction changing means for directing the laser beam which is parallel to the surface of the circuit board to the above light receiving surface. Either of a prism, a mirror, or a diffraction grating is employed for the light direction changing means. In addition, the light receiving device is configured as a photo diode for detecting the timing to scan the laser beam.

Hereinafter, embodiments of the present invention will be described with reference to the accompanying drawings.

### First Embodiment

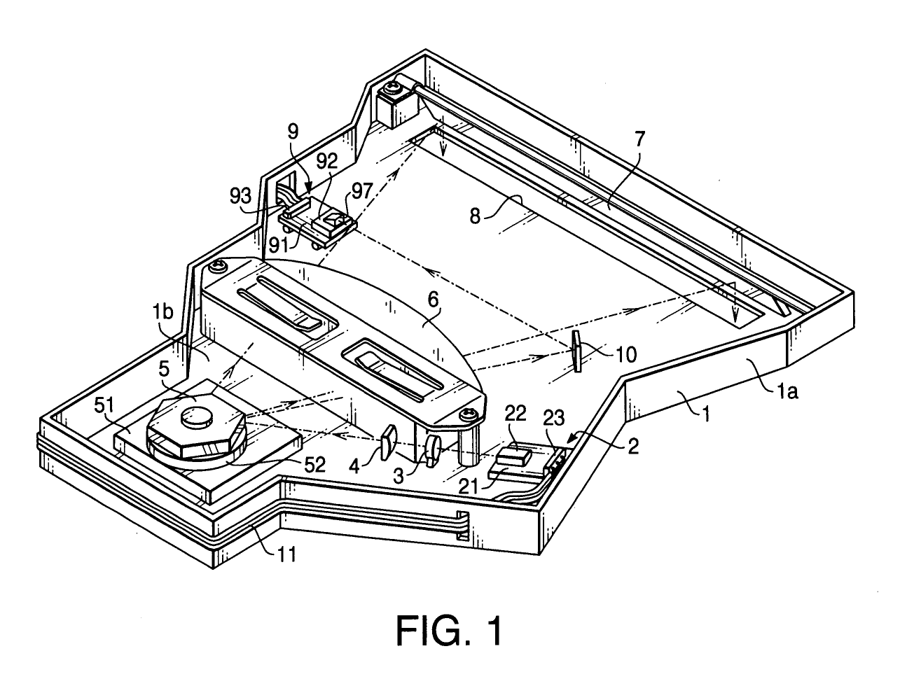

FIG. 1 is a schematic perspective view of a laser scanning device according to a first embodiment of the present invention. The laser scanning device is provided with an LD unit 2, a collimating lens 3, a cylindrical lens 4, a polygon mirror 5, and an fθ lens 6 in a housing 1 with a peripheral wall 1a. The polygon mirror 5 is configured as a low-profile mirror that is formed to be a planer shape of hexagon or octagon of which peripheral surfaces are reflecting surfaces, and is driven by a polygon motor 52 mounted on a polygon substrate 51 to rotate with a plane of rotation parallel to the surface of the polygon substrate 51. The polygon substrate 51 is fixed on a bottom face 1b of the housing 1, and thereby the polygon mirror 5 is rapidly rotated with a plane of rotation parallel to the bottom face 1b of the housing 1. The LD unit 2, collimating lens 3, and cylindrical lens 4 are aligned along a horizontal direction in which an optical axis extends. The LD unit 2, as described below in detail, is configured to have a circuit board 21 which is formed with printed wiring thereon and a laser diode (LD) on the circuit board 21, and is fixed parallel to and on the bottom face 1b of the housing 1. The collimating lens 3 makes a laser beam emitted radially from the LD unit 2 collimated, and the cylindrical lens 4 forms the collimated laser beam to be a laser beam converging in an auxiliary scanning direction. These lenses 3 and 4 are rigidly supported by respective supporting members on the bottom face 1b of the housing 1 (a detailed explanation regarding this point is omitted). Thereby, the laser beam emitted from the LD of the LD unit 2 is incident to the polygon mirror 5 as a laser beam converging in the auxiliary scanning direction.

Moreover, the low-profile fθ lens 6 with a small height is arranged in an area which is scanned with the laser beam deflected by the polygon mirror 5, and controls the laser beam to be scanned in the main scanning direction with constant speed. There is arranged a reflecting mirror 7 extending in the main scanning direction on an opposite side of the bottom face 1b to the polygon mirror 5 with respect to the fθ lens 6, and there is provided a slit 8 opening along the main scanning direction on the bottom face 1b beneath the reflecting mirror 7. The laser beam transmitted through the fθ lens 6 is reflected downward in a perpendicular direction to the bottom face 1b by the reflecting mirror 7, and is directed through the slit 8 downward below the bottom face 1b. In addition, it is noted that below the bottom face 1b, there is provided a photoconductive drum, which is not shown in FIG. 1, facing the slit 8, and the main laser scanning is carried out on a photosensitive surface of the photoconductive drum. It is needless to say that the auxiliary laser scanning is carried out by rotation of the photoconductive drum around a rotating axis.

Moreover, in the housing 1, there are provided a beam detector (BD) mirror 10 that reflects the laser beam transmitted through the fθ lens 6 in a horizontal direction, on a part out of the main scanning area with respect to the photoconductive drum, and a BD unit 9 as a light receiving device according to the present invention, which is fixed on a location to which the laser beam reflected by the BD mirror 10 is directed. The BD unit 9, as described in detail below, is configured to have a circuit board 91 formed with printed wiring thereon and a light receiving device such as a photo diode on the circuit board, and is fixed on the bottom face 1b of the housing 1 with the surface thereof parallel to the bottom face 1b. The LD unit 2 and the BD unit 9 are electrically connected with one another and a below-mentioned controller by a flat cable 11 provided along the peripheral wall 1a of the housing 1.

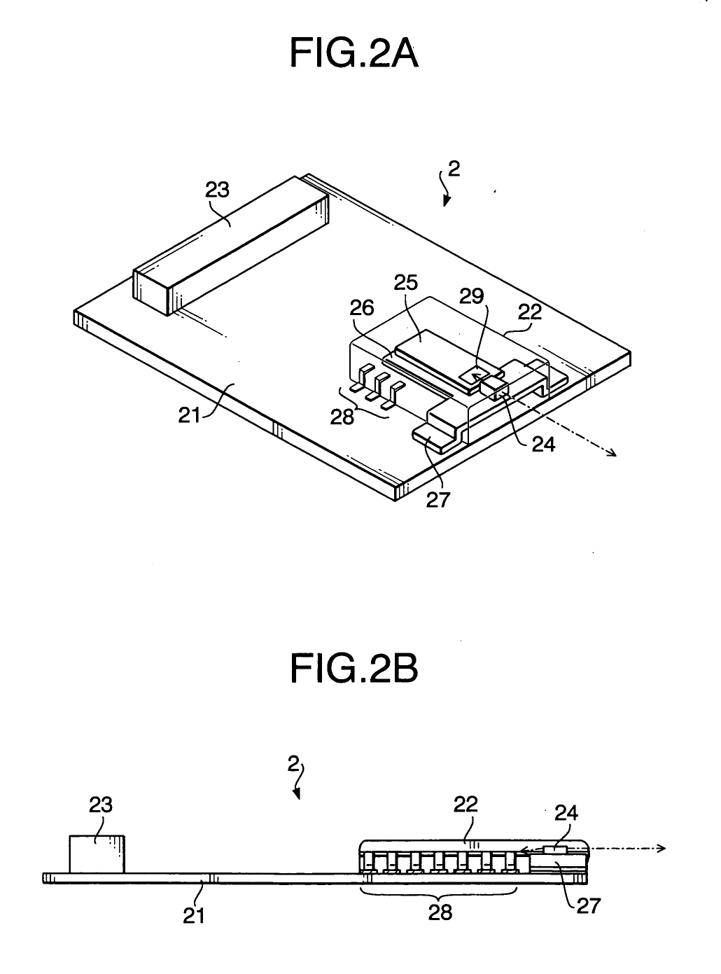

FIGS. 2A and 2B are a schematic perspective view of the LD unit 2 and a schematic side view thereof, respectively. On the circuit board 21, there are mounted an integrated IC 22 that integrally includes a laser diode (LD) chip 24 and a driving circuit chip 25, and a connecter 23. The integrated IC 22 (hereinafter, referred to as an LDIC) is a device that is integrally provided with the LD chip 24 and the monolithic driving circuit chip 25 for driving the LD chip 24, which are together mounted on a lead frame 26, in a package made from a material such as resin, and is configured such that the LD chip 24 and the driving circuit chip 25 are electrically connected with one another in the package, and the driving circuit chip 25 makes the LD chip 24 emit the laser beam which can be directed out of one side of the package. A part of the lead frame 26 is formed as a heat sink 27 that is thermally connected with the LD chip 24. In addition, the LDIC 22 is configured as a small outline package (SOP) that has a plurality of leads 28 extending from two sides of the package, and is mounted parallel to and on the circuit board 21. Additionally, the LDIC 22 is electrically connected with the connecter 23 through wiring that is not shown in FIGS. 2A and 2B. The LDIC 22 is located along an end line of the circuit board 21, and the laser beam is emitted from the LD chip 24 along the planer surface of the circuit board 21. Further, in a part of the driving circuit chip 25, there is integrally formed a photo diode (PD) 29 as a light receiving device for monitoring the laser beam emitted from a back surface opposite to a laser-emitting surface of the LD chip 24, and the LDIC is configured such that the PD 29 can receive the laser beam emitted from the back surface, directly or with the laser beam reflected by a reflecting means such as a prism.

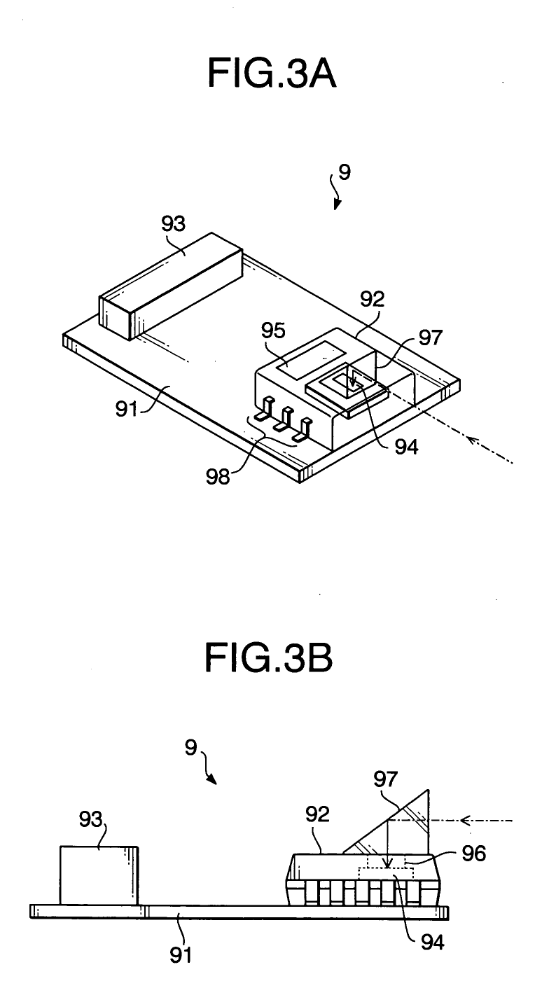

FIGS. 3A and 3B are a schematic perspective view and a schematic side view of the BD unit 9, respectively. On the circuit board 91, there are provided an integrated IC 92 that integrally includes a photo diode (hereinafter, simply referred to as a BD) 94 and a beam detecting circuit 95, and a connecter 93. The integrated IC 92 (hereinafter, referred to as a BDIC) is configured as a monolithic IC that integrally includes the BD 94 and the beam detecting circuit 95 that detects and processes light receiving signals while the BD 94 is receiving the laser beam, in a package made from a material such as resin. On an upper surface of the BDIC 92, there are provided a light receiving window 96 opening to expose a light receiving surface of the BD 94, and a rectangular prism formed from transparent resin, which is integrated on the package so as to cover the light receiving window 96. The rectangular prism 97 is placed opposite the light receiving surface of the BD 94 with a horizontal surface of the rectangular prism 97 parallel to the light receiving surface, with another vertical surface of the rectangular prism 97 along an end line of the circuit board 91. In addition, similar to the LDIC, the BDIC is also configured as a SOP that has a plurality of leads 98 extending from two sides of the package, and is mounted parallel to and on the circuit board 91, and is electrically connected with the connecter 93.

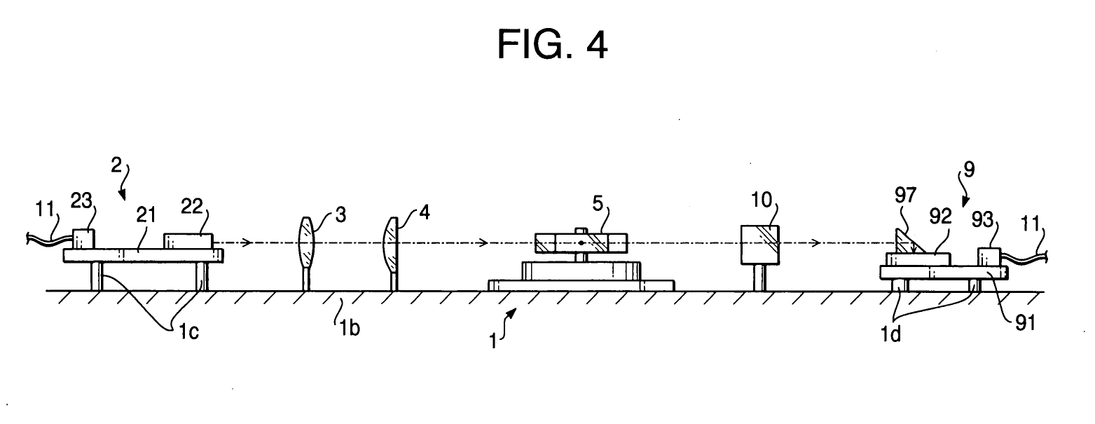

The LD unit 2 and the BD unit 9 configured in these ways, as shown in FIG. 4 which illustrates a laterally-viewed schematic optical system of the laser scanning device, are fixed on bosses 1c and 1d provided on the bottom face 1b of the housing 1 by screws which are not shown in FIG. 4, respectively. In the LD unit 2, the heights of the bosses 1c and the in-plane direction of the circuit board 21 are set such that the optical axis of the laser beam emitted from the LDIC 22 is in alignment with that of each of the collimating lens 3 and the cylinder lens 4. Moreover, in the BD unit 9, the heights of the bosses 1d and the in-line direction of the circuit board 91 are set such that the vertical surface of the rectangular prism 97 is perpendicular to the optical axis of the laser beam reflected by the BD mirror 10.

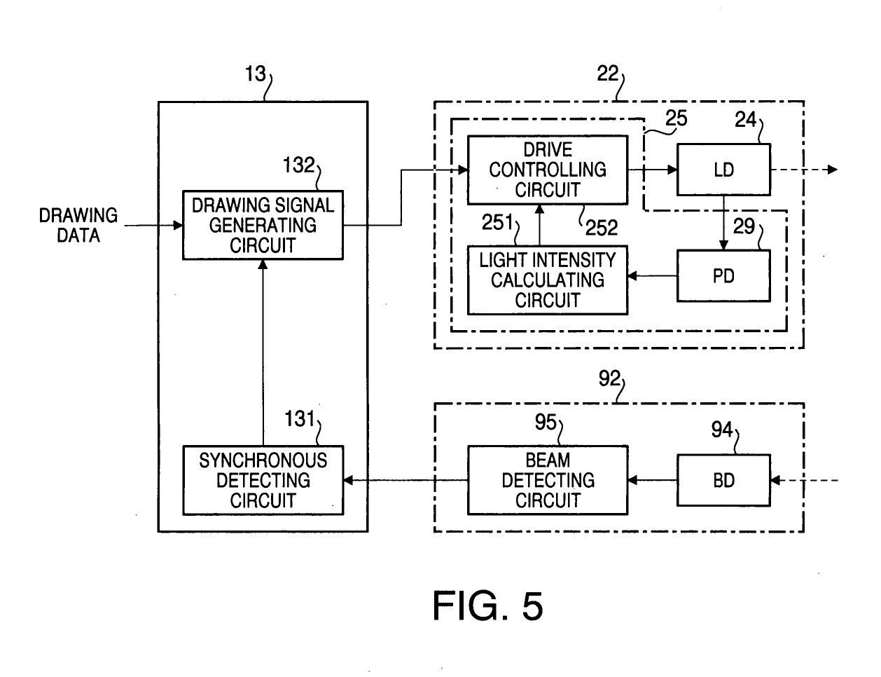

Each of the connecter 20 of the LD unit 2 and the connecter 93 of the BD unit 9 is electrically connected with the controller shown in FIG. 5 through the flat cable 11. FIG. 5 is a block diagram illustrating a circuit configuration of the LDIC 22, BDIC 92, and controller 13. The BDIC 92 is integrally provided with the beam detecting circuit 95 that detects the laser beam on the basis of the light receiving signals of the laser beam received by the BD 94. The LDIC 22 is integrally provided with a light intensity calculating circuit 251 that detects the light intensity of the laser beam received by the PD 29 and a drive controlling circuit 252 that controls a driving current supplied to the LD chip 24 in the driving circuit chip 25, together with the LD chip 24 and the PD 29. On the other hand, the controller 13 is provided with a synchronous detecting circuit 131 that detects laser scanning timing on the basis of the light receiving signals detected by the beam detecting circuit 95 of the BDIC 92 and a drawing signal generating circuit 132 that generates drawing signals on the basis of inputted drawing data and an output from the synchronous detecting circuit 131. In other words, in the LD unit 2, the drive controlling circuit 252 and the light intensity calculating circuit 251 are integrated as an IC together with the LD chip 24, and, in the BD unit 9, the beam detecting circuit 95 is integrated as an IC together with the BD 94.

In the laser scanning device with the aforementioned configuration, when the drawing signals are inputted from the controller 13, the drive controlling circuit 252 of the LDIC 22, in the LD unit 2, generates driving signals for making the LD chip 24 emit the laser beam with required intensity and timing to be supplied to the LD chip 24 according to the drawing signals and light intensity signals calculated by the light intensity calculating circuit 251. Thereby, the LD chip 24 is allowed to generate and emit the laser beam. At this time, the laser beam is emitted from an end surface of the circuit board 21 of the LD unit 2 in a direction parallel to the surface of the circuit board 21. The emitted laser beam is collimated by the collimating lens 3, and is converged in the auxiliary scanning direction by the cylinder lens 4, and is directed to the polygon mirror 5. Then, the laser beam is scanned in the main scanning direction by rapid rotation of the polygon mirror 5 with a scanning speed controlled constant by the fθ lens 6, and is reflected by the reflecting mirror 7, and passes through the slit 8, to carry out the main laser scanning on the photosensitive surface of the photoconductive drum which is not shown in the accompanying drawings.

In addition, a part of the laser beam that is reflected and scanned by the polygon mirror 6 is reflected by the BD mirror 10 to be incident on the vertical surface of the rectangular prism 97. The incident laser beam is reflected downward beneath the rectangular prism 97 thereby, and is incident on the light receiving surface of the BD 94 that faces upward in a vertical direction. The BD 94 outputs a light receiving current according to the light intensity of the incident laser beam, and the current is converted to the light receiving signals by the beam detecting circuit 95. The light receiving signals are transmitted to the controller 13, and the synchronous detecting circuit 131 thereof generates the synchronizing signals. The drawing signals synchronized by the synchronizing signals are transmitted to the LD unit 2. During the above operation, the laser beam emitted from the back surface of the LD chip 24 of the LDIC 22 is received by the PD 29 of the driving circuit chip 25, and the light intensity calculating circuit 251 calculates the light intensity and transmits the light intensity signals based on the calculation to the drive controlling circuit 252. As mentioned before, when the drive controlling circuit 25 receives the drawing signals from the controller 13, the drive controlling circuit 252 generates the driving signals that allow the LD chip 24 to emit the laser beam with required intensity and timing, and supplies the driving signals to the LD chip 24 to control the light emission of the LD chip 24.

Thus, in the laser scanning device of the first embodiment, the LD unit 2 is configured such that the laser beam is emitted parallel to the surface of the circuit board 21, and is fixed parallel to and on the bottom face 1b of the housing 1, and the BD unit 9 is configured such that the laser beam is received parallel to the surface of the circuit board 91, and is fixed parallel to and on the bottom face 1b of the housing 1. Thereby, even though the circuit board 21 of the LD unit 2 and the circuit board 91 of the BD unit 9 are formed with necessary widths and depths to be provided with the LDIC 22 and the BDIC 92, respectively, and the respective connecters 23 and 93 on the circuit boards 21 and 91, the height of the laser scanning device is restricted by the largest one of the heights of the connecters 23 and 93, the LDIC 22, and the BDIC 92. In the first embodiment, the height of the LD unit 2 is restricted by the height of the connecter 23, and the height of the BD unit 9 is restricted by the height of the BDIC 92 that is provided with the rectangular prism 97 thereon. In either case, since these heights are dramatically smaller than the widths and the depths of the circuit boards 21 and 91, the height of the housing 1 can be reduced, and, as a result, it can be attained to make the laser scanning device thinner shaped.

### Second Embodiment

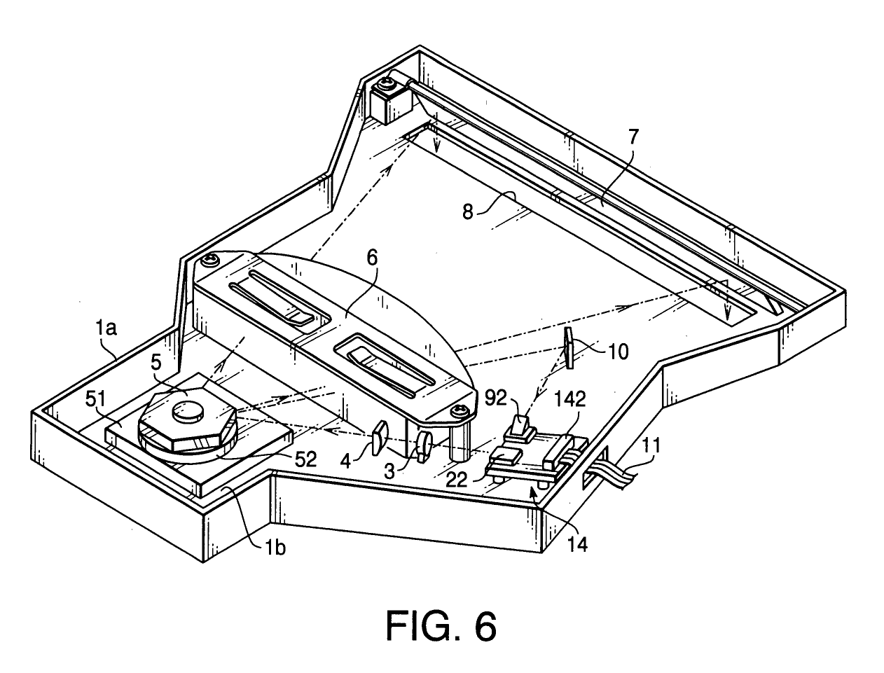

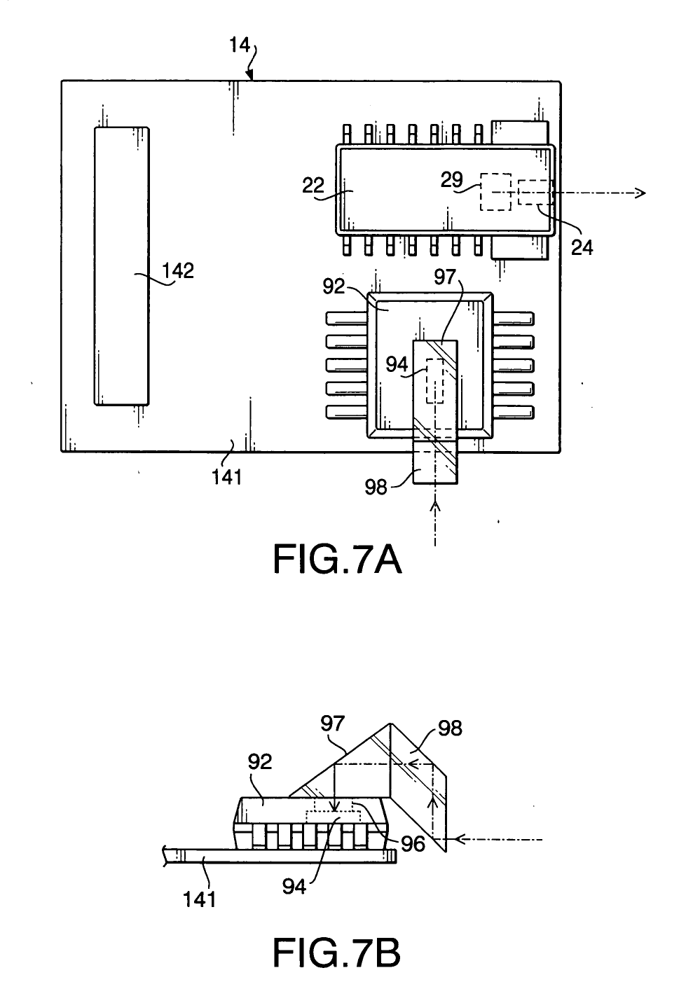

FIG. 6 schematically shows a perspective view of a laser scanning device of a second embodiment according to the present invention. Each of components in common with the first embodiment will be given the same reference number, and the explanation thereof will be omitted. In the second embodiment, the BD unit 9 and the LD unit 2 are configured to be a single board as an LD-BD unit 14, which is provided on the bottom face 1b of the housing 1. Additionally, the BD mirror 10 that is provided in the housing 1 of the laser scanning device of the first embodiment is directed such that the laser beam transmitted through the fθ lens 6 can return to the LD-BD unit 14. The LD-BD unit 14, as a top view thereof is shown in FIG. 7A, is provided with a circuit board 141 that is formed with printed wiring thereon, the LDIC 22 that is located on the circuit board 141 along a first side thereof, and the BDIC 92 that is located on the circuit board 141 along a second side thereof perpendicular to the first side. In addition, a connecter 142 is provided on the circuit board 141 along a third side thereof opposite to the first side. The constitution of the LDIC 22 is the same as the first embodiment. The constitution of the BDIC, as a side view is shown in FIG. 7A, is different from the first embodiment in a shape of a prism. In the second embodiment, a parallelogram prism 98 is integrally attached to the vertical front surface of the rectangular prism 97, and a surface of the parallelogram prism 98 on which the laser beam is incident is located at the same level as the surface of the LDIC 22 from which the laser beam emits. The parallelogram prism 98 shifts the level of the light path by reflections of the laser beam on two oblique planes of the parallelogram prism 98 such that the laser beam can be incident on the vertical front surface of the rectangular prism 97.

An operation of the laser scanning device with the aforementioned constitution is the same as the first embodiment. Simply explaining, according to signals from the controller 13, the drive controlling circuit 252 of the LDIC 22 generates the driving signals that enable to emit the laser beam with required intensity and timing, and supplies the driving signals to the LD chip 24. Thereby, the LD chip 24 generates and emits the laser beam. At this time, the laser beam is emitted from an end surface of the circuit board 21 of the LDIC 22 in a direction parallel to the surface of the circuit board 21. The emitted laser beam is collimated by the collimating lens 3, and is converged in the auxiliary scanning direction by the cylinder lens 4 to be directed to the polygon mirror 5. Then, the laser beam is scanned in the main scanning direction by rapid rotation of the polygon mirror 5 with a scanning speed controlled constant by the fθ lens 6, and is reflected by the reflecting mirror 7, and passes through the slit 8, to carry out the main laser scanning on the photosensitive surface of the photoconductive drum which is not shown in the accompanying drawings.

In addition, although a part of the laser beam that is reflected and scanned by the polygon mirror 6 is reflected by the BD mirror 10, in the second embodiment, the reflected laser beam is directed to the LD-BD unit 14 to be incident to the parallelogram prism 98 thereof. The incident laser beam is reflected by two oblique planes of the parallelogram prism 98, and is then incident to the rectangular prism 97 to be reflected downward beneath the rectangular prism 97 thereby, and is incident on the light receiving surface of the BD 94 that faces upward in a vertical direction. According to the light receiving current outputted from the BD 94, the synchronizing signals are generated in the controller 13. In addition, the laser beam emitted from the back surface of the LD chip 24 of the LDIC 22 is received by the PD 29 of the driving circuit chip 25, and the light intensity signals are generated. Thereby, the drive controlling circuit 25 generates the driving signals that allow the LD chip 24 to emit the laser beam with required intensity and timing, and supplies the driving signals to the LD chip 24 to control the light emission of the LD chip 24.

Thus, in the laser scanning device of the second embodiment, the single LD-BD unit 14 is configured to direct the laser beam emitted from the LD chip 24 in a direction parallel to the surface of the circuit board 141, while receiving the laser beam that is incident to the LD-BD unit 14 from another direction parallel to the surface of the circuit board 141, and is fixed parallel to and on the bottom face 1b of the housing 1. Therefore, even though the circuit board 141 of the LD-BD unit 14 is formed with necessary width and depth to be provided with the LDIC 22, the BDIC 92, and the connecter 142 on the circuit board 141, the height of the laser scanning device is restricted by the largest one of the heights of the connecter 142, the LDIC 22, and the BDIC 92. In the second embodiment, the height of the LD-BD unit 14 is restricted by the height of the BDIC 92 that is provided with the parallelogram prism 98 and the rectangular prism 97 thereon. Since the height of the LD-BD unit 14 is dramatically smaller than the width and the depth of the circuit board 141, the height of the housing 1 can be reduced, and, as a result, it can be attained to make the laser scanning device thinner shaped. Moreover, the laser scanning device of the second embodiment is advantageous in that the footprint thereof can be reduced, because the LD unit and the BD unit are integrated as the single LD-BD unit 14, and thereby the space in the housing 1 is more saved when the LD-BD unit 14 is placed in the housing 1.

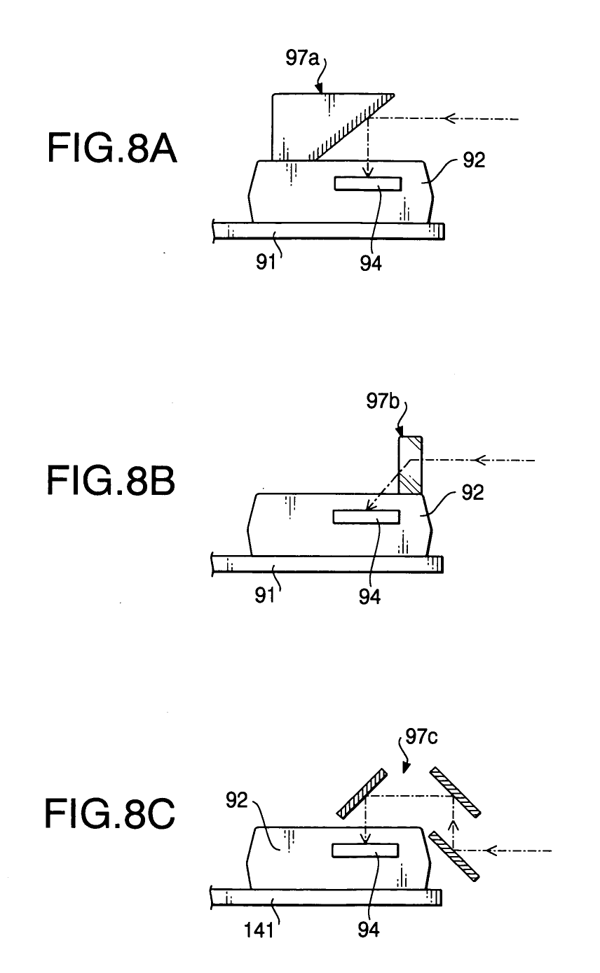

In the constitution of the BDIC 92 in the BD unit 9 of the first embodiment, the rectangular prism 97 may be replaced for a mirror 97a as shown in FIG. 8A. Further, the rectangular prism 97 may be replaced for a diffraction grating 97b as shown in FIG. 8B to detect diffracted light. Moreover, in the constitution of the BDIC 22 in the LD-BD unit 14 of the second embodiment, the rectangular prism 97 and the parallelogram prism 98 are replaced for a mirror structure 97c formed by combination of a plurality of mirrors, as shown in FIG. 8C.

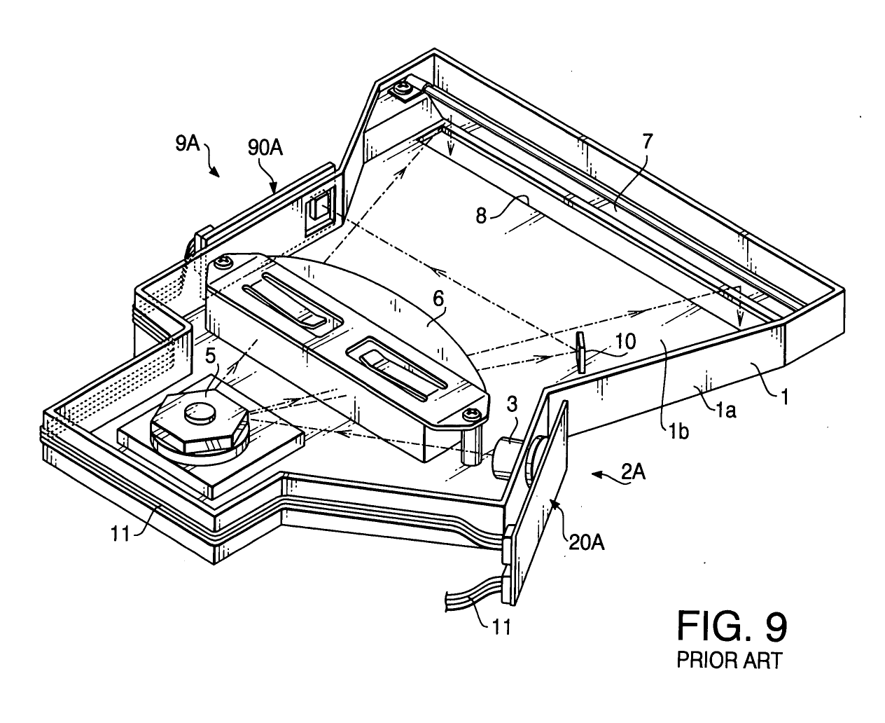

In addition, when the LD unit 2 and the BD unit 9 are structured on separate circuit boards as described in the first embodiment, at least the LD unit 2 should be configured to emit the laser beam in a direction parallel to the surface of the circuit board 21. Because, in general, the side length of the LD unit 2 is larger than that of the BD unit 9, and therefore, the height of the laser scanning device is restricted by the side length of the LD unit 2 in the case of the conventional constitution as shown in FIG. 9. Further, in a certain type of laser scanning device, the BD unit 9 as a light receiving device is not integrally incorporated thereinto, and is integrated with the photoconductive drum separated from the laser scanning device. In such a laser scanning device, the side length of the BD unit has no influence on the height of the laser scanning device. The present disclosure relates to the subject matter contained in Japanese Patent Application No. P2064-247812, filed on Aug. 27, 2004, which is expressly incorporated herein by reference in its entirely.

What is claimed is:

1. A laser scanning device capable of scanning a laser beam on a photosensitive surface, comprising:
a laser emitting system configured to emit the laser beam to be scanned;
a first board mounting the laser emitting system; and
a laser scanning system configured to receive the laser beam emitted from the laser emitting system and scan the laser beam in a scanning direction,
wherein the laser emitting system is adapted to emit the laser beam in a direction substantially parallel to the surface of the first board, and
wherein the first board is arranged with the surface thereof substantially parallel to the scanning direction.

2. The laser scanning device according to claim 1, further comprising a laser detecting system configured to detect the laser beam to output laser detecting signals,
wherein the laser detecting system, which is mounted on the surface of the first board, is adapted to detect the laser beam coming from a direction parallel to the surface of the first board.

3. The laser scanning device according to claim 1, further comprising:
a laser detecting system configured to detect the laser beam to output laser detecting signals; and
a second board mounting the laser detecting system,
wherein the laser detecting system is adapted to detect the laser beam coming from a direction parallel to the surface of the second board, and
wherein the second board is arranged with the surface thereof substantially parallel to the scanning direction.

4. The laser scanning device according to claim 1,
wherein the laser scanning system includes a low-profile polygon mirror that is configured to scan the laser beam in the scanning direction by rotation with a plane of rotation which is parallel to the scanning direction.

5. The laser scanning device according to claim 4,
wherein the laser scanning system includes a scanning speed controlling system that is configured to control the laser beam reflected by the polygon mirror to be scanned in the scanning direction with constant scanning speed.

6. The laser scanning device according to claim 1, wherein the laser emitting system includes:
a laser emitting device that emits the laser beam; and
a laser driving system that drives the laser emitting device.

7. The laser scanning device according to claim 6, wherein the laser emitting system includes:
a laser monitoring device that receives a part of the laser beam emitted from the laser emitting device and outputs a current depending on the intensity of the laser beam; and
a light intensity calculating system that calculates the intensity of the laser beam from the current and outputs light intensity signals,
wherein the laser driving system controls the laser emitting device to emit the laser beam with required intensity based on the light intensity signals.

8. The laser scanning device according to claim 2, wherein the laser detecting system includes:
a laser detecting device that receives a part of the laser beam emitted from the laser emitting device and outputs a current depending on the light intensity of the received laser beam; and
a laser detecting signal generating system that generates laser detecting signals on the basis of the current.

9. The laser scanning device according to claim 8,
wherein the laser detecting device includes a laser detecting surface on which the laser beam to be detected is incident, the laser detecting surface being substantially parallel to the scanning direction, and
wherein the laser detecting system includes a laser direction changing system that is configured to change the direction of the laser beam such that the laser beam is incident on the laser detecting surface.

10. The laser scanning device according to claim 9,
wherein the laser direction changing system is configured employing at least one of a reflecting device that reflects the laser beam, a deflecting device that deflects the laser beam, and a diffracting device that diffracts the laser beam.

11. The laser scanning device according to claim 3, wherein the laser detecting system includes:
a laser detecting device that receives a part of the laser beam emitted from the laser emitting device and outputs a current depending on the light intensity of the received laser beam; and
a laser detecting signal generating system that generates laser detecting signals on the basis of the current.

12. The laser scanning device according to claim 11,
wherein the laser detecting device includes a laser detecting surface on which the laser beam to be detected is incident, the laser detecting surface being substantially parallel to the scanning direction, and
wherein the laser detecting system includes a laser direction changing system that is configured to change the direction of the laser beam such that the laser beam is incident on the laser detecting surface.

13. The laser scanning device according to claim 12,
wherein the laser direction changing system is configured employing at least one of a reflecting device that reflects the laser beam, a deflecting device that deflects the laser beam, and a diffracting device that diffracts the laser beam.

14. A laser scanning device capable of scanning a laser beam on a photosensitive surface, comprising:
a laser emitting system configured to emit the laser beam to be scanned, the laser emitting system including a laser emitting device that emits the laser beam, a laser driving system that drives the laser emitting device, a laser monitoring device that receives a part of the laser beam emitted from the laser emitting device and outputs a current depending on the intensity of the laser beam, and a light intensity calculating system that calculates the intensity of the laser beam from the current and outputs light intensity signals;
a laser detecting system configured to detect the laser beam to output laser detecting signals, the laser detecting system including a laser detecting device that receives a part of the laser beam emitted from the laser emitting device and outputs a current depending on the light intensity of the received laser beam, and a laser detecting signal generating system that generates laser detecting signals on the basis of the current;
a first board mounting the laser emitting system and the laser detecting system; and
a laser scanning system configured to receive the laser beam emitted from the laser emitting system and scan the laser beam in a scanning direction,
wherein the laser emitting system is adapted to emit the laser beam in a direction substantially parallel to the surface of the first board,
wherein the laser driving system controls the laser emitting device to emit the laser beam with required intensity based on the light intensity signals,
wherein the laser detecting system is adapted to detect the laser beam coming from a direction parallel to the surface of the first board, and
wherein the first board is arranged with the surface thereof substantially parallel to the scanning direction.

15. The laser scanning device according to claim 14, further comprising a controlling system that controls timing for modulating the laser beam.

16. The laser scanning device according to claim 15, wherein the controlling system includes:
a synchronous detecting system that receives the laser detecting signals from the laser detecting signal generating system of the laser detecting system and outputs synchronizing signals; and
a drawing signal generating system that receives externally-inputted drawing data and the laser detecting signals, and generates synchronized drawing signals,
wherein the drawing signals are transmitted to the drive controlling system in order to control the laser emitting device to emit the laser beam with required timing.

17. A laser scanning device capable of scanning a laser beam on a photosensitive surface, comprising:
a laser emitting system configured to emit the laser beam to be scanned, the laser emitting system including a laser emitting device that emits the laser beam, a laser driving system that drives the laser emitting device, a laser monitoring device that receives a part of the laser beam emitted from the laser emitting device and outputs a current depending on the intensity of the laser beam, and a light intensity calculating system that calculates the intensity of the laser beam from the current and outputs light intensity signals;
a first board mounting the laser emitting system;
a laser scanning system configured to receive the laser beam emitted from the laser emitting system and scan the laser beam in a scanning direction;
a laser detecting system configured to detect the laser beam to output laser detecting signals, the laser detecting system including a laser detecting device that receives a part of the laser beam emitted from the laser emitting device and outputs a current depending on the light intensity of the received laser beam, and a laser detecting signal generating system that generates laser detecting signals on the basis of the current; and
a second board mounting the laser detecting system,
wherein the laser emitting system is adapted to emit the laser beam in a direction substantially parallel to the surface of the first board,
wherein the laser driving system controls the laser emitting device to emit the laser beam with required intensity based on the light intensity signals,
wherein the laser detecting system is adapted to detect the laser beam coming from a direction parallel to the surface of the second board,
wherein each of the first and second boards is arranged with the surface thereof substantially parallel to the scanning direction.

18. The laser scanning device according to claim 17, further comprising a controlling system that controls timing for modulating the laser beam.

19. The laser scanning device according to claim 18, wherein the controlling system includes:
a synchronous detecting system that receives the laser detecting signals from the laser detecting signal generating system of the laser detecting system and outputs synchronizing signals; and
a drawing signal generating system that receives externally-inputted drawing data and the laser detecting signals, and generates synchronized drawing signals,
wherein the drawing signals are transmitted to the drive controlling system in order to control the laser emitting device to emit the laser beam with required timing.
